(19) United States
(12) Patent Application Publication
(10) Pub. No.: US 2026/0226081 A1
(43) Pub. Date: Aug. 6, 2026

(54) PROCESS AND CATALYST COMPOSITION FOR PREPARING ORGANOSILICON COMPOUNDS VIA ISOMERIZATION OF INTERNAL OLEFINS AND HYDROSILYLATION

(71) Applicant: Dow Silicones Corporation, Midland, MI (US)

(72) Inventors: Evan Bergman, Midland, MI (US); Matthew Jeletic, Midland, MI (US); Eric Joffre, Midland, MI (US)

(21) Appl. No.: 19/149,912

(22) PCT Filed: Jan. 26, 2024
(86) PCT No.: PCT/US2024/013017

§ 371 Date: Jul. 22, 2025

Related U.S. Application Data
(60) Provisional application No. 63/451,935, filed on Mar. 14, 2023.

(51) Int. Cl. C07F 7/08; B01J 31/28; C07F 7/20

(52) U.S. Cl. CPC C07F 7/0879; B01J 31/28; C07F 7/20; B01J 2231/323; B01J 2231/52

(57) ABSTRACT

A process for making an organosilicon compound is provided. The process involves isomerization and hydrosilylation starting with an internal olefinic compound and a silyl hydride compound. A catalyst composition including a Platinum hydrosilylation reaction catalyst and an Iridium (I)—ligand complex is capable of catalyzing the isomerization and hydrosilylation reactions.

### CROSS REFERENCE TO RELATED APPLICATIONS

This application claims the benefit of U.S. Provisional Patent Application Ser. No. 63/451,935 filed on 14 Mar. 2023 under 35 U.S.C. § 119 (e). U.S. Provisional Patent Application Ser. No. 63/451,935 is hereby incorporated by reference.

### FIELD

A process and catalyst composition for preparing an organosilicon compound is disclosed. More particularly, the process involves isomerization of an internal olefinic compound to form a terminal olefinic compound and hydrosilylation of the terminal olefinic compound to form a reaction product comprising the organosilicon compound.

### INTRODUCTION

Typical industrial hydrosilylation catalysts such as Speier's and Karstedt's catalyst are generally known to hydrosilylate terminal olefins but are significantly less reactive in hydrosilylating internal olefins. When hydrosilylating a mixture of terminal and internal olefins, unreacted internal olefins may be disposed of, resulting in raw material inefficiencies. High catalyst loadings and high reaction temperature can be used to react the internal olefin to mitigate this difficulty in some cases, but high catalyst loadings are not cost-effective, higher temperatures result in more power consumption, which reduces cost-effectiveness, and high catalyst loading and high temperature can lead to excessive side reactions which reduce quality and yield.

Steric aspects of the internal double bond and other factors exert influence on hydrosilylation reaction. Hydrosilylation of oct-1-ene with trichlorosilane using Karstedt's catalyst is quite fast, but significant isomerization of the double bond occurs and notable formation of the corresponding oct-2-enes occurs. See, for example, “Platinum Catalysis Revisited—Unraveling Principles of Catalytic Olefin Hydrosilylation” by Meister, et al., ACS Catal. 2016, 6, 1274-1284.

There is an industry need to provide organosilicon compounds via hydrosilylation in processes with high yield and selectivity.

### SUMMARY

A catalyst composition includes at least 0.5 ppm of a Platinum hydrosilylation reaction catalyst; and at least 50 ppm of an Iridium (I) complex. This catalyst composition is useful for catalyzing isomerization and hydrosilylation reactions. The catalyst composition may be used in a process for preparing an organosilicon compound, wherein the process comprises:
1) combining starting materials comprising
   A) an olefinic component comprising A-1) an internal olefinic compound, wherein the internal olefinic compound is linear or branched, has at least 4 carbon atoms per molecule, and has at least one internal double bond per molecule;
   B) a silyl hydride compound having at least one silicon bonded hydrogen atom per molecule; and
   C) the catalyst composition.

### DETAILED DESCRIPTION

Starting materials A), the olefinic component, B) the silyl hydride compound, C) the catalyst composition, and optionally D) a solvent may be used in the process introduced above. These starting materials are described in detail, below.

### A) Olefinic Component

Starting material A) in the process described herein is an olefinic component. The olefinic component comprises A-1) an internal olefinic compound, wherein the internal olefinic compound is linear or branched, has at least 4 carbon atoms per molecule, and has at least one internal double bond per molecule. The internal olefinic compound may be an internal olefinic hydrocarbon. For example, the internal olefinic hydrocarbon may have formula A-1-1):

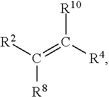

where R² has empirical formula —CₚH₍₂ₚ₊₁₎, where subscript p≥1; R⁴ has empirical formula —C_{q}H_{(2q+1)}, where subscript q≥1; R⁸ has empirical formula —CᵣH₍₂ᵣ₊₁₎, where subscript r≥0; and R¹⁰ has empirical formula —CₛH₍₂ₛ₊₁₎, where subscript s≥0. Each of R² and R⁴ may independently be linear or branched. Each of R⁸ and R¹⁰ may be H (e.g., when r and/or s=0). Alternatively, each of R⁸ and R¹⁰ may independently be linear or branched (i.e., when r and/or s is 2 or more). Alternatively, subscript p may be 1 to 8. Alternatively, subscript q may be 1 to 8. Alternatively, subscript r may be 1 to 8. Alternatively, subscript s may be 1 to 8. Alternatively, a quantity (p+q+r+s) may be 2 to 14, alternatively 2 to 6. Examples of suitable internal olefinic hydrocarbons include, but are not limited to, 2-butene (cis, trans, or mixture thereof); 2-pentene (cis, trans, or mixture thereof); 2-methyl-2-butene; 2-hexene (cis, trans, or mixture thereof); 2-methyl-2-pentene; trans-4-methyl-2-pentene; 3-hexene (cis, trans, or mixture thereof); 2,3-dimethyl-2-butene; 3-methyl-2-pentene (cis, trans, or mixture thereof); 2-methyl-2-heptene; trans-2-methyl-3-heptene; trans-6-methyl-3-heptene; trans-2-octene; trans-3-octene; trans-4-octene; 2,3,4-trimethyl-2-pentene; 2,4,4-trimethyl-2-pentene; trans-5-decene; and 2-methyl-2-undecene, all of which are commercially available from Millipore Sigma of St. Louis, Missouri, USA. Alternatively, A-1) may be selected from the group consisting of 2-octene, 4-octene, 2-methyl-2-butene, and 2,3-dimethyl-2-butene.

Alternatively, A-1) the internal olefinic hydrocarbon may be substituted with an oxygen atom. For example, the internal olefinic compound may be an alkenyl ether of formula

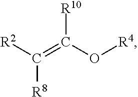

where R², R⁴, R⁸, and R¹⁰ are as described above. For example, the ether is exemplified by ethyl-1-propenyl ether (cis, trans, or mixture thereof), which is also available from Millipore Sigma.

Starting material A) in the process described herein may optionally further comprise A-2) a terminal olefinic compound in addition to A-1) the internal olefinic compound. The terminal olefinic compound may be, for example, a terminal alkene having 2 to 16 carbon atoms per molecule. For example, octenes may be provided in mixtures including 1-octene along with one or more of 2-octene (cis, trans, or mixtures thereof); 3-octene (cis, trans, or mixtures thereof); and 4-octene (cis, trans, or mixtures thereof). Alternatively, starting material A) may comprise a mixture of terminal and internal octenes from a process used to produce linear low density polyethylene (LLDPE). Starting material A-1) may be 100 weight % of starting material A), i.e., A-2) the terminal olefinic compound is optional, and its amount may be 0. Alternatively, starting material A) may comprise 99 weight % to 100 weight % of A-1) the internal olefinic compound, alternatively 99 weight % to <100 weight % of A-1) the internal olefinic compound. Alternatively, starting material A) may comprise >1 weight % of the terminal olefinic compound, e.g., when a by-product from a process such as LLDPE production process is used herein. For example, in the by-product from LLDPE production the weight ratio of A-1) the internal olefinic compound to A-2) the terminal olefinic compound may range from 1.2/1 to 1/1.2; alternatively 1.1/1 to 1/1.1; alternatively 1/1.

The amount of starting material A) the olefinic component depends on various factors including the selection and amounts of starting materials A) and B), the alkenyl content of starting material A), and the silicon bonded hydrogen content of starting material B). However, the amount of starting material A), the olefinic component, and the amount of starting material B), the silyl hydride compound may be selected such that a molar ratio of silicon bonded hydrogen atoms from B) the silyl hydride compound to double bonds in A) the olefinic component (B/A molar ratio) may be 100/1 to 1/100, alternatively 5/1 to 1/5, alternatively 1/1 to 1/5, alternatively 3/1 to 1/3, and alternatively 1/1.

### B) Silyl Hydride Compound

Starting material B) in the process described herein is a silyl hydride compound. The silyl hydride compound may be B-1) a silane or B-2) a polyorganohydrogensiloxane. Starting material B-1), the silane, has formula HₓSiR¹_{y}X_{z}, where each R¹ is independently selected from the group consisting of an aliphatically saturated monovalent hydrocarbon group and an aliphatically saturated monovalent halogenated hydrocarbon group, each X is an independently selected hydrolyzable substituent (e.g., halogen or alkoxy), subscript x is an integer with a value of 1 to 3, subscript y is in integer with a value of 0 to 3, and subscript z=4−x−y.

In the formula above, each R¹ is an aliphatically saturated monovalent hydrocarbon group or an aliphatically saturated monovalent halogenated hydrocarbon group. Suitable monovalent hydrocarbon groups include, but are not limited to, alkyl such methyl, ethyl, propyl, butyl, pentyl, hexyl, heptyl, octyl, decyl, dodecyl, undecyl, and octadecyl; cycloalkyl such as cyclopentyl and cyclohexyl; aryl such as phenyl, tolyl, xylyl, and naphthyl; and aralkyl such as benzyl, 1-phenylethyl and 2-phenylethyl. Examples of suitable monovalent halogenated hydrocarbon groups include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Each X may be a halogen atom exemplified by chlorine, fluorine, bromine, and iodine; alternatively chlorine. Alternatively, X may have formula OR¹, where R¹ is as described above. Alternatively X may be alkoxy such as methoxy or ethoxy. Examples of suitable silanes for starting material B) are exemplified by trichlorosilane of formula HSiCl₃, dimethylchlorosilane of formula Me₂HSiCl, trimethoxysilane of formula HSi(OMe)₃, triethoxysilane of formula (HSiOEt)₃, or methyldimethoxysilane of formula MeHSi(OMe)₂, trimethylsilane of formula HSiMe₃, or triethylsilane of formula HSiEt₃.

Alternatively, the silyl hydride compound may comprise B-2) an organohydrogensiloxane comprising two or more siloxane units selected from, HR¹₂SiO_{1/2}, R¹₃SiO_{1/2}, HR¹SiO_{2/2}, R¹₂SiO_{2/2}, R¹SiO_{3/2}, HSiO_{3/2} and SiO_{4/2} units, with the proviso that at least one unit per molecule contains a silicon bonded hydrogen atom. In the preceding formulae, each R¹ is independently selected from the monovalent hydrocarbon groups and monovalent halogenated hydrocarbon groups, which free of aliphatic unsaturation, and which are as described above for starting material B-1). The organohydrogensiloxane may be linear, branched, cyclic, resinous, or a combination thereof. Alternatively, the organohydrogensiloxane may be linear or branched. Alternatively, the organohydrogensiloxane may be linear.

Starting material B-2), the organohydrogensiloxane, may have unit formula (I): (R³₃SiO_{1/2})ₑ(R³₂HSiO_{1/2})_{f}(R³₂SiO_{2/2})_{g}(R³HSiO_{2/2})ₕ(R³SiO_{3/2})ᵢ(HSiO_{3/2})ⱼ(SiO_{4/2})ₖ, where each R³ is independently selected from the group consisting of an aliphatically saturated monovalent hydrocarbon group, an aliphatically saturated monovalent halogenated hydrocarbon group, and a hydrolyzable substituent (where the monovalent hydrocarbon group and the monovalent halogenated hydrocarbon group are as described above for R¹, and the hydrolyzable substituent is as described above for X); subscripts e, f, g, h, i, j, and k each represent average numbers of units in the unit formula and have values such that e≥0, f≥0, g≥0, h≥0, i≥0, j≥0, k≥0, a quantity (f+g+j)≥1, and 2≤(e+f+g+h+i+j+k)≤10,000.

Alternatively, B-2) the organohydrogensiloxane may comprise unit formula (II): (R¹₂HSiO_{1/2})ₕ(R¹₃SiO_{1/2})ᵢ(R¹₂SiO_{2/2})ⱼ(R¹HSiO_{2/2})ₖ, where each R¹ is independently selected from the group consisting of monovalent hydrocarbon groups and monovalent halogenated hydrocarbon groups, which free of aliphatic unsaturation, and which are as described above, subscripts h, i, j, and k represent average numbers of each unit per molecule and have values such that, 0≤h≤2, 0≤i≤2, (h+i)=2, 0≤j<2000, 0<k<2000, 0<(j+k)<2000, and 2≤(h+k)≤2000. Alternatively, h may be 2, and i may be 0. Alternatively, h may be 0 and i may be 2. Alternatively, j may be 0 to 5, alternatively 1 to 4, alternatively 2 to 4, and alternatively 3 to 3.5. Alternatively, k may be 1 to 10, alternatively 2 to 9, alternatively 3 to 8, alternatively 4 to 7, and alternatively 5 to 6. Alternatively, i and k may be 0, h may be 2, and j may be 0 to 1000, alternatively 0 to 500, alternatively 0 to 250, and alternatively 0 to 100.

Alternatively, starting material (B-2) the organohydrogensiloxane may comprise Formula (III), Formula (IV), or a combination of both, where
Formula (III) is R¹₃SiO(R¹₂SiO)ᵣ(R¹HSiO)ᵤSiR¹₃, and
Formula (IV) is R¹₂HSiO(R¹₂SiO)ᵥ(R¹₂SiO)_{w}SiR¹₂H.

In formulae (III) and (IV) above, subscript t has an average value ranging from 0 to 2000, subscript u has an average value ranging from 2 to 2000, subscript v has an average value ranging from 0 to 2000, and subscript w has an average value ranging from 0 to 2000. Each R¹ is as described above. Alternatively, subscript t may be 0 to 1,000; alternatively 0 to 500, alternatively 0 to 250, and alternatively 0 to 100. Alternatively, subscript u may be 2 to 1,000; alternatively 2 to 500, alternatively 2 to 250, and alternatively 2 to 100. Alternatively, subscript v may be 0 to 1,000; alternatively 0 to 500, alternatively 0 to 250, and alternatively 0 to 100. Alternatively, subscript w may be 2 to 1,000; alternatively 2 to 500, alternatively 2 to 250, and alternatively 2 to 100.

Polyorganohydrogensiloxanes for starting material B-2) are exemplified by:
a) dimethylhydrogensiloxy-terminated polydimethylsiloxane,
b) dimethylhydrogensiloxy-terminated poly(dimethylsiloxane/methylhydrogensiloxane),
c) dimethylhydrogensiloxy-terminated polymethylhydrogensiloxane,
d) trimethylsiloxy-terminated poly(dimethylsiloxane/methylhydrogensiloxane),
e) trimethylsiloxy-terminated polymethylhydrogensiloxane,
f) a resin consisting essentially of H(CH₃)₂SiO_{1/2} units and SiO_{4/2} units, and
g) a combination thereof.

Polyorganohydrogensiloxanes are also commercially available, such as those available from Gelest, Inc. of Morrisville, Pennsylvania, USA, for example, HMS-H271, HMS-071, HMS-993; HMS-301 and HMS-301 R, HMS-031, HMS-991, HMS-992, HMS-993, HMS-082, HMS-151, HMS-013, HMS-053, HAM-301 (octyl functional), HPM-502 (phenyl functional) and HMS-HM271. Other polyorganohydrogensiloxanes include DOWSIL™ 6-3570 Polymer, DOWSIL™ SH1107 Fluid, XIAMETER™ MHX-11007 Fluid, and XIAMETER™ OFS-5057 Fluid, all of which are commercially available from Dow. Methods of preparing linear, branched, and cyclic organohydrogenpolysiloxanes suitable for use herein, such as hydrolysis and condensation of organohalosilanes, are well known in the art, see for example U.S. Pat. No. 3,957,713 to Jeram et al. and U.S. Pat. No. 4,329,273 to Hardman, et al. Methods of preparing organohydrogenpolysiloxane resins suitable for use herein are exemplified, e.g., in U.S. Pat. Nos. 5,310,843; 4,370,358; and 4,707,531. And, U.S. Pat. No. 2,823,218 to Speier, et al., discloses organohydrogensiloxane oligomers and linear polymers, e.g., 1,1,3,3-tetramethyldisiloxane; 1,1,1,3,3-pentamethyldisiloxane; 1,1,1,3,5,5,5-heptamethyltrisiloxane; bis-trimethylsiloxy-terminated polymethylhydrogensiloxane homopolymer; bis-trimethylsiloxy-terminated poly(dimethyl/methylhydrogen)siloxane copolymer; and cyclic polymethylhydrogensiloxanes.

The amount of starting material B) depends on various factors including the selection and amounts of starting materials A) and B), the alkenyl content of starting material A), and the silicon bonded hydrogen content of starting material B).

### C) Catalyst Composition

Starting material C) is a catalyst composition comprising C-1) a Platinum hydrosilylation reaction catalyst, and C-2) an Iridium (T) complex. The Iridium (T) complex may have at least one, alternatively at least two olefinic moieties, which are either linked or separate. For example, the Iridium (I) complex may have at least one ligand such as 1,5-cyclooctadiene or 2,5-norbornadiene, per molecule. Alternatively, the Iridium (I) complex may have two ligands such as cyclooctene or ethylene, per molecule. Alternatively, the Iridium (I) complex may have at least one ligand selected from the group consisting of 1,5-cyclooctadiene, cyclooctene, 2,5-norbornadiene, and ethylene. Alternatively, C) the catalyst composition may consist essentially of C-1) the Platinum hydrosilylation reaction catalyst, and C-2) the Iridium (I) complex. Alternatively, C) the catalyst composition may consist of C-1) the Platinum hydrosilylation reaction catalyst, and C-2) the Iridium (I) complex.

### C-1) Pt Hydrosilylation Reaction Catalyst

Starting material C-1) is a Platinum hydrosilylation reaction catalyst. The Platinum hydrosilylation reaction catalyst will promote a reaction between the alkenyl groups in starting material (A) the olefinic compound and the silicon bonded hydrogen atoms in starting material (B) the silyl hydride compound. Said hydrosilylation reaction catalyst comprises platinum. The hydrosilylation reaction catalyst may be (C1-1) platinum metal; (C1-2) a compound of platinum metal, for example, chloroplatinic acid (Speier's Catalyst), chloroplatinic acid hexahydrate, platinum dichloride, (C1-3) a complex of the compound with an alkenyl-functional organopolysiloxane, or (C1-4) a platinum compound microencapsulated in a matrix or coreshell type structure. Complexes of platinum with alkenyl-functional organopolysiloxanes include a vinyldimethylsiloxane complex with platinum, such as 1,3-diethenyl-1,1,3,3-tetramethyldisiloxane complexes with platinum (Karstedt's Catalyst) and Pt(0) complex in tetramethyltetravinylcyclotetrasiloxane (Ashby's Catalyst). Alternatively, the hydrosilylation reaction catalyst may be (C1-5) a compound or complex, as described above, microencapsulated in a resin matrix. Starting material C1) may be homogeneous, or heterogeneous, optionally with a support. Alternatively, starting material C1) may be homogeneous. Specific examples of suitable platinum-containing catalysts for use herein include chloroplatinic acid, either in hexahydrate form or anhydrous form, or a platinum-containing catalyst which is obtained by a method comprising reacting chloroplatinic acid with an aliphatically unsaturated organosilicon compound such as divinyltetramethyldisiloxane, or alkene-platinum-silyl complexes as described in U.S. Pat. No. 6,605,734 to Roy. These alkene-platinum-silyl complexes may be prepared, for example by mixing 0.015 mole (COD)PtCl₂ with 0.045 mole COD and 0.0612 moles HMeSiCl₂, where COD represents cyclooctadienyl or other platinum complex including a mono-anionic ligand and optionally a neutral coordinating ligand, e.g., a Pt COD complex with an alkenyl-functional silylalkyl group, as disclosed in U.S. Pat. No. 11,008,353 or 11,253,846, both to Girolami, et al. Other exemplary hydrosilylation reaction catalysts are described in U.S. Pat. No. 2,823,218 to Speier; U.S. Pat. No. 3,159,601 to Ashby; U.S. Pat. No. 3,220,972 to Lamoreaux; U.S. Pat. No. 3,296,291 to Chalk, et al.; U.S. Pat. No. 3,419,593 to Willing; U.S. Pat. No. 3,516,946 to Modic; U.S. Pat. No. 3,814,730 to Karstedt; U.S. Pat. No. 3,928,629 to Chandra; U.S. Pat. No. 3,989,668 to Lee, et al.; U.S. Pat. No. 4,766,176 to Lee, et al.; U.S. Pat. No. 4,784,879 to Lee, et al.; U.S. Pat. No. 5,017,654 to Togashi; U.S. Pat. No. 5,036,117 to Chung, et al.; and U.S. Pat. No. 5,175,325 to Brown; and EP 0 347 895 A to Togashi, et al. Suitable hydrosilylation reaction catalysts for starting material (C-1) are commercially available, for example, SYL-OFF™ 4000 Catalyst and SYL-OFF™ 2700 are available from The Dow Chemical Company of Midland, Michigan, USA.

Alternatively, starting material (C-1) may be a platinum (0)—siloxane complex, which is known in the art and described, for example in U.S. Pat. No. 3,814,730, which is hereby incorporated by reference. The complex may consist essentially of chemically combined platinum and unsaturated organosiloxane of the formula RₘR′ₙR″ₒSiO_{(4-m-n-o)/2}, where each R is an independently selected monovalent hydrocarbon group that is free of aliphatic unsaturation, each R′ is an independently selected monovalent aliphatically unsaturated hydrocarbon group, each R″ is selected from R′ groups chemically combined with platinum, subscript m is 0 to 2, subscript n is 0 to 2, subscript o is 0.0002 to 3, and a quantity (m+n+o) is 1 to 3.

The platinum (0)—siloxane complex may be prepared by combining a platinum halide and an unsaturated organosilicon material, which may be an organosiloxane of formula R_{c}R′_{d}SiO_{(4-c-d)/2}, where R and R′ are as described above, subscript c has a value equal to 0 to 2, inclusive, and subscript d has a value equal to 0.0002 to 3, inclusive, and the sum of c and d is equal to 1 to 3, inclusive. The platinum halide may be hexachloroplatinic acid or a metal salt such as NaHPtCl₆·nH₂O, KHPtCl₆·nH₂O, Na₂PtCl₆·nH₂O, or K₂PtCl₆·nH₂O. The complex may be made by effecting contact between the unsaturated organosilicon material and the platinum halide for the production of a mixture having a concentration of inorganic halogen, treating the resulting mixture to effect removal of available inorganic halogen, and recovering the complex.

Alternatively, the unsaturated organosilicon material may be an unsaturated organosiloxane of formula

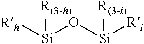

where R is alkyl, R′ is alkenyl, subscript h is an integer of 1 to 3, subscript i is an integer of 1 to 3, and a quantity (h+i)≥2. Suitable alkyl groups for R include methyl, ethyl, propyl and butyl; alternatively methyl and ethyl; and alternatively methyl. Suitable alkenyl groups for R′ include vinyl, allyl, and hexenyl; alternatively vinyl and allyl; and alternatively vinyl. Alternatively, the unsaturated organosiloxane may be selected from the group consisting of 1,3-divinyl-1,1,3,3-tetramethyldisiloxane; 1,1,3-trivinyltrimethyldisiloxane; 1,1,3,3-tetravinyl-1,3-dimethyldisiloxane; and hexavinyldisiloxane.

Alternatively, the complex may be platinum (0)—1,3-divinyl-1,1,3,3-tetramethyldisiloxane complex, e.g., comprising formula:

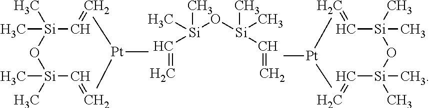

Starting material (C-1) may be one Platinum hydrosilylation reaction catalyst or a combination of two or more of the Platinum hydrosilylation reaction catalysts described above. Alternatively, starting material C-1) may be one Platinum hydrosilylation reaction catalyst, e.g., Karstedt's catalyst. The amount of C-1) the Platinum hydrosilylation reaction catalyst used in the method will depend on various factors including the selection of starting materials A), B), and C-2), however, the amount of C-1) Platinum hydrosilylation reaction catalyst is sufficient to catalyze hydrosilylation reaction of SiH and terminal alkenyl groups, alternatively the amount of catalyst is sufficient to provide at least 0.5 ppm, alternatively at least 2 ppm, alternatively at least 10 ppm, alternatively at least 15 ppm, alternatively at least 20 ppm, alternatively at least 25 ppm, and alternatively at least 30 ppm, by mass of the platinum metal based on combined amounts of starting materials A), B), and C) used in step (1) of the process described herein. At the same time, the amount of catalyst is sufficient to provide up to 500 ppm, alternatively up to 250 ppm, alternatively up to 200 ppm, alternatively up to 150 ppm, and alternatively up to 100 ppm by mass of the platinum metal, on the same basis. Alternatively, the amount of starting material C-1) may be 0.5 ppm to 200 ppm, alternatively 2 ppm to 150 ppm, and alternatively 10 ppm to 100 ppm, on the same basis.

### C-2) Iridium (I)—Ligand Complex

An Iridium (I)—ligand complex is used in the catalyst composition and process described herein. The Iridium (I)—ligand complex comprises, per molecule, at least one neutral olefinic ligand. For example, the Iridium (I)—ligand complex may comprise at least one ligand from the group consisting of 1,5-cyclooctadiene ligand, a cyclooctene ligand, a 2,5-norbornadiene ligand, and an ethylene ligand. The Iridium (I)—ligand complex may have formula: [Ir(R⁵)_{b}(R⁶)_{c}]_{d}, where subscript b is 1 or 2; R⁵ is a 1,5-cyclooctadiene ligand, a cyclooctene ligand, a 2,5-norbornadiene ligand, or an ethylene ligand; subscript c is 0, 1 or 2; R⁶ is a ligand that can be activated off the complex at a temperature less than a boiling point of the organohydrogensiloxane oligomer; and subscript d is 1 or 2. Activating with respect to R⁶ may be performed by any convenient means, such as heating at a temperature less than the boiling point of the silyl hydride compound, adding a silver salt, or by photochemical or electrochemical means. Examples of ligands suitable for R⁶ include a halogen atom, a beta-ketoester ligand, a halogenated beta-ketoester ligand, an alkoxy ligand, a cyanoalkyl ligand, an aryl ligand, and a heteroaryl ligand. Examples of suitable halogen atoms include bromine (Br), chlorine (Cl) and iodine (I). Alternatively, the halogen atom may be Cl. Examples of beta-ketoester ligands include acetyl acetonate (acac). Examples of halogenated beta-ketoesters include hexafluoro acetylacetonate (hfacac). Examples of alkoxy ligands include methoxy, ethoxy, and propoxy. Alternatively the alkoxy ligand may be methoxy. Examples of suitable cyanoalkyl ligands include CH₃CN, acetonitrile, and tetrahydrofuran (THF). Examples of suitable aryl ligands include phenyl, benzyl, or indenyl. Examples of suitable heteroaryl ligands include pyridine.

In the formula above, R⁵ is a 1,5-cyclooctadiene ligand, a cyclooctene ligand, a 2,5-norbornadiene ligand, or an ethylene ligand. Alternatively, R⁵ may be selected from the group consisting of a 1,5-cyclooctadiene ligand, a cyclooctene ligand, and a 2,5-norbornadiene ligand. Alternatively, R⁵ may be selected from the group consisting of a 1,5-cyclooctadiene ligand and a cyclooctene ligand. Alternatively, R⁵ may be a 1,5-cyclooctadiene ligand. The Iridium (I) complex may be homogeneous or heterogeneous, optionally with a support. Alternatively, starting materials C1) and C2) may be on the same support. Alternatively, starting material C2) may be homogeneous.

Examples of suitable Iridium (I) complexes include those shown below in Table 1. For example, complexes including a 1,5-cyclooctadiene ligand are exemplified by, but not limited to, [Ir(I)CODCl]₂, Ir(I)CODacac, Ir(I)COD₂BARF, [Ir(I)COD(OMe)]₂, Ir(I)COD(hfacac), IrCOD(CH₃CN)₂BF₄, Ir(I)COD(pyridine)PF₆, Ir(I)COD(indenyl), and mixtures thereof; wherein COD represents a 1,5-cyclooctadiene group, BARF represents tetrakis(3,5-bis(trifluoromethyl)phenyl)borate, acac represents acetyl acetonate, and hfacac represents hexafluoro acetylacetonate. Examples of suitable Iridium (I) complexes including a cyclooctene ligand are exemplified by, but not limited to, [Ir(COE)₂Cl]₂, where COE represents a cyclooctene group.

The amount of C-2) the Iridium (I) complex is sufficient to isomerize internal alkenyl groups to terminal alkenyl groups, alternatively the amount of C-2) the Iridium (I) complex catalyst is sufficient to provide at least 25 ppm, alternatively at least 50 ppm, alternatively at least 55 ppm, alternatively at least 60 ppm, alternatively at least 65 ppm, and alternatively at least 70 ppm, by mass of iridium metal based on combined amounts of starting materials (A), (B), and (C) used in step (1) of the process described herein. At the same time, the amount of C-2) the Iridium (I) complex is sufficient to provide up to 500 ppm, alternatively up to 250 ppm, alternatively up to 200 ppm, alternatively up to 150 ppm, and alternatively up to 100 ppm by mass of the iridium metal, on the same basis.

### D) Solvent

Starting material D) is an optional solvent that may be used to deliver one or more of the starting materials. The solvent may be added facilitate introduction of certain starting materials, such as B) the silyl hydride compound, such as when a resin is used, and/or C) the catalyst composition. Solvents that can be used herein are those that help fluidize the starting materials of the composition, but essentially do not react with the starting materials. The solvent may be selected based on solubility the starting materials and volatility of the solvent. The solubility refers to the solvent being sufficient to dissolve and/or disperse a starting material. Volatility refers to vapor pressure of the solvent.

Suitable solvents include polyorganosiloxanes with suitable vapor pressures, such as hexamethyldisiloxane, octamethyltrisiloxane, hexamethylcyclotrisiloxane and other low molecular weight polyorganosiloxanes, such as 0.5 to 1.5 cSt DOWSIL™ 200 Fluids and DOWSIL™ OS FLUIDS, which are commercially available from The Dow Chemical Company.

Alternatively, the solvent may comprise an organic solvent. The organic solvent can be an alcohol such as methanol, ethanol, isopropanol, butanol, or n-propanol; an aromatic hydrocarbon such as benzene, toluene, ethylbenzene or xylene; an aliphatic hydrocarbon such as heptane, hexane, or octane; a halogenated hydrocarbon such as dichloromethane, 1,1,1-trichloroethane or methylene chloride; or a combination thereof.

The amount of D) the solvent will depend on various factors including the type of solvent selected and the amount and type of other starting materials selected for the composition. However, the amount of solvent may range from 0.5 weight % to 99.5 weight %, alternatively 1 weight % to 99 weight %, alternatively 2 weight % to 90 weight %, based on combined weights of starting materials A), B) and C). Solvent can be added before and/or during step 1), for example, to aid mixing and delivery. All or a portion of the solvent may optionally be removed after step 1).

### Process Steps

The starting materials described above are used in the process for preparing the organosilicon compound. The process comprises:
1) combining starting materials comprising
   A) the olefinic component comprising
      A-1) the internal olefinic compound, and optionally A-2) the terminal olefinic compound;
   B) the silyl hydride compound having at least one silicon bonded hydrogen atom per molecule; and
   C) the catalyst composition comprising
      C-1) the Platinum hydrosilylation reaction catalyst, and
      C-2) the Iridium (I) complex; and
   optionally D) the solvent, wherein starting materials A), B), C) and D) and their amounts are as described above. Step 1) products an isomerization and hydrosilylation reaction product comprising the organosilicon compound.

Step 1) of the process may be performed by any convenient means, such as mixing starting materials A), B), and C), and when present D). Typically, starting materials A) and B) are reacted in a vessel or reactor to prepare the organosilicon compound. When the reaction is carried out at an elevated or reduced temperature as described below, the vessel or reactor may be heated or cooled in any suitable manner, e.g. via a jacket, mantle, exchanger, bath, or coils. Starting materials A), B), and C), and optionally D), may be fed together or separately to the vessel, or may be disposed in the vessel in any order of addition, and in any combination. For example, starting materials A) and C), and optionally D), may be added to a vessel, and starting material B) may be added thereto in one aliquot, alternatively starting material B) may be metered into the vessel continuously, or intermittently in two or more aliquots.

Alternatively, starting materials A), B), and optionally D) may be first combined prior to the addition, or may be added to the vessel sequentially, and thereafter starting material C) may be added to the vessel containing starting materials A) and B), and optionally D). In general, reference to the “reaction mixture” herein refers generally to a mixture comprising starting materials A), B), and C), and optionally D), (e.g. as obtained by combining such starting materials, as described above). Each component of the catalyst composition may be added concurrently or sequentially in any order. Starting materials C-1) and C-2) may be combined, optionally by mixing with D) the solvent, before their addition to the vessel. Alternatively, one of starting materials C-1) and C-2) may be combined with D) the solvent.

The process in step 1) may further comprise agitating the reaction mixture. The agitating may enhance mixing and contacting together starting materials A), B), and C), and optionally D), when combined, e.g. in the reaction mixture thereof. Such contacting independently may use other conditions, with (e.g. concurrently or sequentially) or without (i.e., independent from, alternatively in place of) the agitating. The other conditions may be tailored to enhance the contacting, and thus reactions (i.e., isomerization and hydrosilylation), of starting materials A) and B) to form the reaction product comprising the organosilicon compound.

The process in step 1) may further comprise heating the reaction mixture. The temperature depends on various factors including the vapor pressures of starting materials A) and B), and when present D), however the temperature may be 50° C. to 150° C., alternatively 60° C. to 100° C. Step 1) may be performed under ambient atmosphere and pressure, alternatively a reduced oxygen atmosphere, such as 1-2% oxygen and the balance being an inert gas, such as nitrogen.

The process described herein may optionally further comprise one or more additional steps. For example, the process may further comprise step 2): purifying the isomerization and hydrosilylation reaction product prepared in step 1), e.g., to remove and/or recover unreacted starting materials. Purifying may be performed by any convenient means such as stripping and/or distillation with heating and optionally under reduced pressure and/or azeotroping with solvents, filtration, and combinations thereof. The distillation conditions typically include: (i) an elevated temperature; (ii) a reduced pressure; or (iii) both an elevated temperature and reduced pressure. By elevated or reduced, it is meant as compared to room temperature and atmospheric pressure. As understood in the art, the number of trays utilized in any distillation may be optimized, and may influence the rate and/or recovery of the organosilicon compound with respect to the distillate produced. The distillation may be continuous or batch, and may include use of a solvent (e.g. hexane, or toluene, or other solvent described above as starting material D)), such that the distillation may be an azeotropic distillation.

As used herein, purifying the isomerization and hydrosilylation reaction product is typically defined as increasing the relative concentration of the organosilicon compound as compared to other compounds in combination therewith (e.g. in the reaction product or a purified version thereof). As is understood in the art, purifying may comprise removing the other compounds from such a combination (i.e., decreasing the amount of impurities and/or unreacted starting materials combined with the organosilicon compound in the isomerization and hydrosilylation reaction product) and/or removing the organosilicon compound itself from the combination. Any suitable technique and/or protocol for purification may be used. Examples of suitable purification techniques include distilling, stripping, evaporating, extracting, filtering, washing, partitioning, phase separating, adsorption, and chromatography. As will be understood by those of skill in the art, any of these techniques may be used in combination (e.g., sequentially) with any another technique to purify the isomerization and hydrosilylation reaction product. Regardless of the particular technique(s) selected, purifying the isomerization and hydrosilylation reaction product may be performed in sequence (i.e., in line) with the isomerization and hydrosilylation reaction itself, and thus may be automated. Alternatively, purifying may be a stand-alone procedure to which the isomerization and hydrosilylation reaction product comprising the organosilicon compound is subjected.

As a result of purifying the isomerization and hydrosilylation reaction product, the organosilicon compound and an unreacted olefinic component may be recovered. The process may optionally further comprise step 3): repeating the process and recycling the unreacted olefinic component in step 1).

### Product of the Process

The product prepared by the process described herein comprises an organosilicon compound, which comprises a group derived from starting material A) bonded to a silicon atom from starting material B). For example, the organosilicon compound may be an organofunctional silane, which may have formula: R⁷ₓ^{Si}R¹_{y}X_{z}, where subscripts x, y, and z and R¹ and X are as described above, and R⁷ comprises an organic group. Without wishing to be bound by theory, it is thought that R⁷ is formed by isomerizing A-1) the internal olefinic compound to form a terminal olefinic compound and hydrosilylating. For example, when a linear alkene is used as A) the olefinic component in the process described above, then R⁷ is an n-alkyl group of at least 4 carbon atoms. For example, when starting material A-1) is one or more of the internal octenes described above, then R⁷ is an n-octyl group. The product may be, for example, n-octyl dimethylchlorosilane, n-octyltrichlorosilane, n-octyltrimethoxysilane, n-octyltriethoxysilane, n-octyl methyl dimethoxysilane, n-octyltrimethylsilane, or n-octyltriethylsilane. Alternatively, when a branched internal olefinic hydrocarbon is used as starting material A-1), R⁷ will be branched. For example, R⁷ may be 2-methyl-2-butyl, 2,3-dimethyl-2-butyl, or other branched alkyl group derived from the exemplary internal olefinic hydrocarbons described above.

Alternatively, the organosilicon compound prepared by the process described above may have any formula described above for B-2) organohydrogensiloxane, wherein at least one silicon bonded hydrogen atom is replaced with R⁷, as described above. For example, when B-2) comprises 1,1,3,3-tetramethyldisiloxane, the organosilicon compound may comprise formula: Me₂R⁷SiOSiMe₂R⁷. Alternatively, when B-2) comprises 1,1,1,3,3-pentamethyldisiloxane, the organosilicon compound may comprise formula: Me₂R⁷SiOSiMe₃. Alternatively, when B-2) comprises 1,1,1,3,5,5,5-heptamethyltrisiloxane, the organosilicon compound may comprise unit formula MD^{R7}M, where D^{R7} represents a difunctional siloxane unit of formula (MeR⁷SiO_{2/2}), where R⁷ is as defined above. Additional examples of organosilicon compounds that can be prepared by the process herein are described below.

### EXAMPLES

The following examples are to illustrate the invention to one skilled in the art and are not to be construed as limiting the invention set forth in the claims. Starting Materials used in the examples are summarized below in Table 1.

TABLE 1
Starting Materials

| Name here | Chemical Name | Chemical description |
|---|---|---|
| Ir(acac)CO₂ | Dicarbonyl(acetylacetonato) iridium(I) | 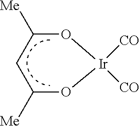 |
| (PPh₃)₂Ir(CO)Cl | Chlorocarbonylbis (triphenylphosphine) iridium(I) | 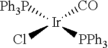 |
| [Ir(COD)Cl]₂ | Chloro-1,5- cyclooctadiene iridium(I) dimer | 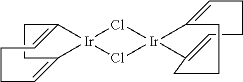 |
| Ir(COD)acac | 1,5- Cyclooctadiene (acetylacetonato)iridium(I) | 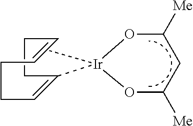 |
| Ir(COD)₂BARF | Bis(1,5-cyclooctadiene) iridium(I) tetrakis [3,5- bis(trifluoromethyl) phenyl]borate, | 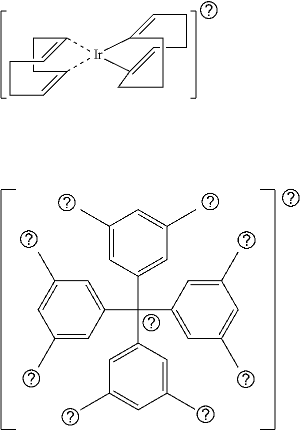 |
| [IrCOD(OMe)]₂ | Di-u-methoxobis (1,5-cyclooctadiene) diiridium(I) | 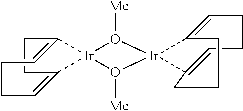 |
| [Ir(COE)₂Cl]₂ | Chlorobis(cyclooctene) iridium(1) dimer | 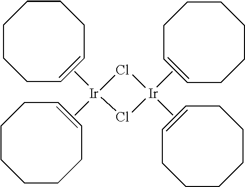 |
| IrCOD(hfacac) | 1,5-Cyclooctadiene (hexafluoroacetylacetonato) iridium(I) | 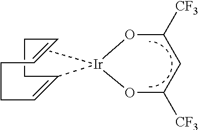 |
| IrCOD(CH,CN)₂BF₄ | Bis(acetonitrile)(1,5- cyclooctadiene)iridium(I) tetrafluoroborate | 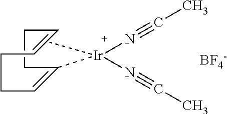 |
| IrCOD(pyridine)₂PF₆ | Bis(pyridine)(1,5- cyclooctadiene)iridium(I) hexafluorophosphate | 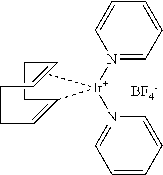 |
| Ir(COD)idenyl | 1,5-Cyclooctadiene (≈5-indenyl)iridium(I) | 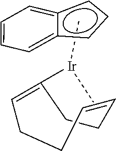 |
| MD′M | 1,1,1,3,5,5,5- | |
| | heptamethyltrisiloxane | |
| 5057s | Telechelic SiH | |
| | terminated | |
| | polydimethylsiloxane | |
| | with DP = 100 | |
| EPE | Ethyl-1-propenyl ether | |
| | mixture of cis and | |
| | trans | |
| 2-Octene | 2-octene | |
| 2M2B | 2-methyl-2-Butene | |
| 23DM2B | 2,3-dimethyl-2-butene | |
| 4-octene | 4-octene | |
| Pt #4 | Karstedt′s catalyst | Structure described above, |
| | | amount of 1% Pt, in toluene |

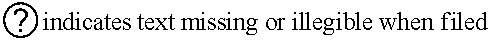

In this Reference Example 1, samples were prepared as follows: In a glove box, vials were placed on a heating block. An olefin and an SiH compound were added to each vial, catalyst(s) were added, and the vials were capped prior to heating. The vials were then heated to 60 degrees C. while stirring. ¹H NMR spectroscopy were taken for each sample after 1 hour at 60 degrees C. and 4 hours to monitor reaction progression. The starting materials, amounts used, and results are shown below in Table 2.

TABLE 2
Samples Prepared and Results

| Sample | | | | Amount | Pt#4 | | Ir | Temp | Conversion | Conversion |
|---|---|---|---|---|---|---|---|---|---|---|
| # | SiH | Amount (g) | olefin | (g) | (ppm) | Ir Cat | (ppm) | (° C.) | (1 h) | (4 h) |
| 1 | MD′M | 3.43 | 2-Octene | 1.73 | 10.00 | [Ir(COD)Cl]₂ | 50.00 | 60.00 | 90% | 99% |
| 2 | MD′M | 3.43 | 2-Octene | 1.73 | 10.00 | [Ir(COD)Cl]₂ | 25.00 | 60.00 | 90% | 93% |
| 3 | MD′M | 3.43 | 2-Octene | 1.73 | 10.00 | [Ir(COD)Cl]₂ | 100.00 | 60.00 | 98% | 98% |
| 4 | MD′M | 3.27 | 2-Octene | 1.73 | 10.00 | [Ir(COD)Cl]₂ | 200.00 | 60.00 | 95% | |
| 5 | MD′M | 3.27 | 2-Octene | 1.73 | 2.00 | [Ir(COD)Cl]₂ | 100.00 | 60.00 | 96% | 100% |
| 6 | MD′M | 3.27 | 2-Octene | 1.73 | 5.00 | [Ir(COD)Cl]₂ | 100.00 | 60.00 | 100% | |
| 7 | MD′M | 3.43 | 2-Octene | 1.73 | 10.00 | Ir(COD)acac | 100.00 | 60.00 | 92% | 97% |
| 8 | MD′M | 3.43 | 2-Octene | 1.73 | 10.00 | Ir(COD)₂BARF | 100.00 | 60.00 | 42% | 40% |
| 9 | MD′M | 3.43 | 2-Octene | 1.73 | 10.00 | [IrCOD(OMe)]₂ | 100.00 | 60.00 | 89% | 98% |
| 10 | MD′M | 3.43 | 2-Octene | 1.73 | 10.00 | [Ir(COE)Cl]₂ | 100.00 | 60.00 | 97% | 98% |
| 11 | MD′M | 3.43 | 2-Octene | 1.73 | 10.00 | IrCOD(hfacac) | 100.00 | 60.00 | 41% | 84% |
| 12 | MD′M | 3.43 | 2-Octene | 1.73 | 10.00 | IrCOD(CH₃CN)₂BF₄ | 100.00 | 60.00 | 32% | 46% |
| 13 | MD′M | 3.43 | 2-Octene | 1.73 | 10.00 | IrCOD(pyridine)₂PF₆ | 100.00 | 60.00 | 60% | 90% |
| 14 | MD′M | 3.43 | 2-Octene | 1.73 | 10.00 | Ir(COD)indenyl | 100.00 | 60.00 | 62% | 95% |
| 15 | MD′M | 3.56 | EPE | 1.45 | 10.00 | [Ir(COD)Cl]₂ | 100.00 | 60.00 | 52% | |
| 16 | 5057S | 4.34 | 2-Octene | 0.66 | 10.00 | [Ir(COD)Cl]₂ | 100.00 | 60.00 | 46% | |
| 17 | MD′M | 4.44 | 2M2B | 1.40 | 10.00 | [Ir(COD)Cl]₂ | 100.00 | 40.00 | 85% | 95% |
| 18 | MD′M | 3.43 | 4-Octene | 1.73 | 10.00 | [Ir(COD)Cl]₂ | 100.00 | 60.00 | 98% | 99% |
| 19 | MD′M | 2.18 | 23DM2B | 3.46 | 10.00 | [Ir(COD)Cl]₂ | 100.00 | 60.00 | 71% | |
| Comp 1 | MD′M | 3.43 | 2-Octene | 1.73 | 0.00 | [Ir(COD)Cl]₂ | 100.00 | 60.00 | 4% | 3% |
| Comp 2 | MD′M | 3.27 | 2-Octene | 1.73 | 10.00 | [Ir(COD)Cl]₂ | 0.00 | 60.00 | 4% | 8% |
| Comp 3 | MD′M | 3.27 | 2-Octene | 1.73 | 10.00 | [Ir(COD)Cl]₂ | 10.00 | 60.00 | 4% | |
| Comp 4 | MD′M | 3.43 | 2-Octene | 1.73 | 10.00 | Ir(acac)CO2 | 100.00 | 60.00 | 4% | 19% |
| Comp 5 | MD′M | 3.43 | 2-Octene | 1.73 | 10.00 | (PPh₃)₂Ir(CO)Cl | 100.00 | 60.00 | 4% | 19% |
| Comp 6 | MD′M | 3.56 | EPE | 1.45 | 10.00 | [Ir(COD)Cl]₂ | 0.00 | 60.00 | 5% | 16% |
| Comp 7 | MD′M | 3.56 | EPE | 1.45 | 10.00 | [Ir(COD)Cl]₂ | 10.00 | 60.00 | 16% | 16% |
| Comp 8 | 5057S | 4.34 | 2-Octene | 0.66 | 10.00 | [Ir(COD)Cl]₂ | 0.00 | 60.00 | 5% | 5% |
| Comp 9 | MD′M | 4.44 | 2M2B | 1.40 | 10.00 | [Ir(COD)Cl]₂ | 0.00 | 60.00 | 0% | 0% |
| Comp 10 | MD′M | 2.18 | 23DM2B | 3.46 | 10.00 | [Ir(COD)Cl]₂ | 0.00 | 60.00 | 0% | <1% |

Conversion in Table 2 refers to the amount of organosilicon compound formed via the isomerization and hydrosilylation reaction after 1 h and 4 h, respectively (conversion to the desired product) as measured by ¹H NMR spectroscopy.

Referring to the data in Table 2, above, comparative examples 1, 4, and 5 and working examples 3 and 5-14 each used the same olefinic compound (2-octene) and silyl hydride compound (MD′M). These results demonstrate that not all Iridium complexes (Comp 4 and 5) can be combined with Karstedt's catalyst to provide a reaction rate enhancement or improvement in yield (>20% yield after 4 h) under the conditions tested. Examples 5-14 indicate that the use of Karstedt's catalyst in combination with an Ir(I) complex including a COD or COE Ir(I) fragment provides for synergistic results with various counter ligands such as Cl, acac or OMe.

Furthermore, comparative example 2 showed that when Pt catalyst was used, but Ir catalyst was not used, yield was poor after 1, 4, and 24 h under the conditions tested. Comparative example 1 showed that when Ir catalyst was used, but Pt catalyst was not used, yield was poor 1, 4, and 24 h under the conditions tested. Comparative example 3 showed that when an insufficient amount of the Ir catalyst was used in combination with the Pt catalyst, yield was still poor. Working examples 1 to 6 showed that using the same olefinic component (2-octene), silyl hydride compound (MD′M), and catalysts (Karstedt's catalyst and [Ir(COD)Cl]₂) as in comparative examples 1-3, but with the amounts of each catalyst as described herein, resulted in drastically improved yields over comparative examples 1-3. These examples show that the combination of C-1) the Platinum hydrosilylation reaction catalyst and C-2) the Iridium (I) complex in the amounts described herein produces an unexpected synergistic effect of improved yield.

Various internal olefinic compounds and silyl hydride compounds were also tested using the catalyst system of this invention in examples 15-19. Comparative examples 6 and 7 used the same silyl hydride compound and olefinic component as example 15, however these results showed that the combination of Platinum hydrosilylation reaction catalyst (Karstedt's catalyst) and Ir complex ([Ir(COD)Cl]₂) in the amounts described herein produced improved yield and increased reaction rate in example 15. Example 15 had 52% yield after only one hour, compared to comparative example 7, which contained 10 ppm of each catalyst, which reached only 16% yield after 1 h, and yield did not increase after 4 h. Comparative examples 8 used the same silyl hydride compound and olefinic component as example 16, but example 16 showed improved yield when 10 ppm of Karstedt's catalyst and 100 ppm of [Ir(COD)Cl]₂ was included. Comparative example 9 and example 17 each used MD′M and 23DM2B, and example 17 had improved conversion when 100 ppm of [Ir(COD)Cl]₂ was included. Comparative example 10 and example 19 each used MD′M and 23DM2B, and example 19 had improved conversion when 100 ppm of [Ir(COD)Cl]₂ was included. These examples show that the combination of starting materials C-1) and C-2) in the amounts described herein, are effective for the isomerization and hydrosilylation reactions of different olefinic compounds and silyl hydride compounds. And, the reactions proceed faster in the working examples than the comparative examples using the same A) olefinic compounds and B) silyl hydride compounds.

### INDUSTRIAL APPLICABILITY

The examples and comparative examples shown above demonstrate that the combination of Platinum hydrosilylation reaction catalyst and Iridium (I) complex used in the amounts described herein produce unexpected benefits of improved raw material efficiency, increased yield, and/or increased reaction rate for hydrosilylation of various internal olefins and silyl hydride compounds. Without wishing to be bound by theory, the present process has improved recycling and circularity by reducing the amount of waste produced, as compared to processes only involving hydrosilylation of terminal olefinic compounds.

### Definitions and Usage of Terms

All amounts, ratios, and percentages herein are by weight, unless otherwise indicated. The articles ‘a’, ‘an’, and ‘the’ each refer to one or more, unless otherwise indicated by the context of specification. The singular includes the plural unless otherwise indicated. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table 3.

TABLE 3
Abbreviations

| Abbreviation | Definitions |
|---|---|
| acac | acetyl acetonate |
| ° C. | degrees Celsius |
| Dow | The Dow Chemical Company of Midland, Michigan, USA |
| g | gram |
| h | hour |
| hfacac | hexafluoro acetylacetonate |
| Me | methyl |
| NMR | nuclear magnetic resonance |
| Ph | phenyl |
| ppm | parts per million by weight |
| THF | tetrahydrofuran |

1. A process for preparing an organosilicon compound, wherein the process comprises:
1) combining starting materials comprising
A) an olefinic component comprising
A-1) an internal olefinic compound, wherein the internal olefinic compound is linear or branched, has at least 4 carbon atoms per molecule, and has at least one internal double bond per molecule; and
optionally A-2) a terminal olefinic compound, wherein the terminal olefinic compound is linear or branched, has at least 4 carbon atoms per molecule, and has at least one terminal double bond per molecule;
B) a silyl hydride compound having at least one silicon bonded hydrogen atom per molecule;
C) a catalyst composition comprising
at least 0.5 ppm of C-1) a Platinum hydrosilylation reaction catalyst; and
at least 25 ppm of C-2) an Iridium (I) complex having at least one ligand comprising one or more olefinic moieties, which are either linked or separate;
thereby producing an isomerization and hydrosilylation reaction product comprising the organosilicon compound.

2. The process of claim 1, where A-1) the internal olefinic compound comprises an internal olefinic hydrocarbon of formula A-1-1): 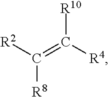
where R² has empirical formula —CₚH₍₂ₚ₊₁₎, where subscript p≥1; and R⁴ has empirical formula —C_{q}H_{(2q+1)}, where subscript q≥1; R⁸ has empirical formula —CᵣH₍₂ᵣ₊₁₎, where subscript r≥0; and R¹⁰ has empirical formula —CₛH₍₂ₛ₊₁₎, where subscript s≥0; and a quantity (p+q+r+s) is 2 to 14.

3. The process of claim 2, where the internal olefinic hydrocarbon is selected from the group consisting of 2-octene, 4-octene, 2-methyl-2-butene, and 2,3-dimethyl-2-butene.

4. The process of claim 3, where A-2) the terminal olefinic compound is present and comprises 1-octene.

5. The process of claim 1, where A-1) the internal olefinic compound comprises an alkenyl ether of formula 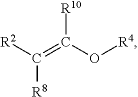
where R² has empirical formula —CₚH₍₂ₚ₊₁₎, where subscript p≥1; and R⁴ has empirical formula —C_{q}H_{(2q+1)}, where subscript q≥1; R⁸ has empirical formula —CᵣH₍₂ᵣ₊₁₎, where subscript r≥0; and R¹⁰ has empirical formula —CₛH₍₂ₛ₊₁₎, where subscript s≥0; and a quantity (p+q+r+s) is 2 to 14.

6. The process of claim 6, where the alkenyl ether comprises ethyl-1-propenyl ether.

7. The process of claim 1, where the silyl hydride compound is selected from the group consisting of B-1) a silane having at least one silicon bonded hydrogen atom per molecule and B-2) an organohydrogensiloxane.

8. The process of claim 7, where B-1) the silane has formula HₓSiR¹_{y}X_{z}, where each R¹ is independently selected from the group consisting of an aliphatically saturated monovalent hydrocarbon group and an aliphatically saturated monovalent halogenated hydrocarbon group, each X is an independently selected hydrolyzable substituent, subscript x is an integer with a value of 1 to 3, subscript y is in integer with a value of 0 to 3, and subscript z=4−x−y.

9. The process of claim 7, where B-2) the organohydrogensiloxane comprises unit formula: (R¹₂HSiO_{1/2})ₕ(R¹₃SiO_{1/2})ᵢ(R¹₂SiO_{2/2})ⱼ(R¹HSiO_{2/2})ₖ, where each R¹ is independently selected from the group consisting of monovalent hydrocarbon groups and monovalent halogenated hydrocarbon groups, which free of aliphatic unsaturation, subscripts h, i, j, and k represent average numbers of each unit per molecule and have values such that, 0≤h≤2, 0≤i≤2, (h+i)=2, 0≤j<2000, 0<k<2000, 0<(j+k)<2000, and 2≤(h+k)≤2000.

10. The process of claim 1, where C-1) the Platinum hydrosilylation reaction catalyst is selected from the group consisting of Karstedt's catalyst, Speier's Catalyst, and platinum on a support.

11. The process of claim 1, where C-2) the Iridium (I)—ligand complex has formula [Ir(R⁵)_{b}(R⁶)_{c}]_{d}, where subscript b is 1 or 2; each R⁵ is independently selected from the group consisting of a 1,5-cyclooctadiene ligand, a cyclooctene ligand, a 2,5-norbornadiene ligand, and an ethylene ligand; subscript c is 0, 1 or 2; R⁶ is a ligand that can be activated off the complex at a temperature less than a boiling point of the silyl hydride compound; and subscript d is 1 or 2.

12. The process of claim 11, where C-2) the Iridium (I)—ligand complex is selected from the group consisting of Chloro-1,5-cyclooctadiene iridium(I) dimer; 1,5-Cyclooctadiene(acetylacetonato)iridium(I); Bis(1,5-cyclooctadiene)iridium(I) tetrakis[3,5-bis(trifluoromethyl)phenyl]borate; Di-μ-methoxobis(1,5-cyclooctadiene)diiridium(I); Chlorobis(cyclooctene)iridium(I) dimer; 1,5-Cyclooctadiene(hexafluoroacetylacetonato)iridium(I); Bis(acetonitrile)(1,5-cyclooctadiene)iridium(I) tetrafluoroborate; Bis(pyridine)(1,5-cyclooctadiene)iridium(I) hexafluorophosphate; 1,5-Cyclooctadiene(≈5-indenyl)iridium(I); and mixtures thereof.

13. The process of claim 1, further comprising:
2) purifying the isomerization and hydrosilylation reaction product comprising the organosilicon compound, thereby recovering the organosilicon compound and an unreacted olefinic component.

14. A catalyst composition suitable for isomerization and hydrosilylation reaction, wherein the catalyst composition consists of:
at least 0.5 ppm of C-1) a Platinum hydrosilylation reaction catalyst; and
at least 25 ppm of C-2) an Iridium (I) complex having at least one ligand comprising one or more olefinic moieties, which are either linked or separate.

15. The catalyst composition of claim 14, where
C-1) the Platinum hydrosilylation reaction catalyst is present in an amount of 0.5 to 500 ppm; and
C-2) the Iridium (I) complex has at least one ligand selected from the group consisting of 1,5-cyclooctadiene, cyclooctene, 2,5-norbornadiene, and ethylene; and the Iridium (I) complex is present in an amount of 25 ppm to 500 ppm.

16. The catalyst composition of claim 14, where
C-1) the Platinum hydrosilylation reaction catalyst is present in an amount of 0.5 to 500 ppm; and
C-2) the Iridium (I) complex is present in an amount of 25 ppm to 500 ppm.

17. The process of claim 13, further comprising 3) repeating the process and recycling the unreacted olefinic component in step 1).

18. The process of claim 9, where the polyorganohydrogensiloxane comprises 1,1,1,3,5,5,5-heptamethyltrisiloxane.

19. The process of claim 9, where the polyorganohydrogensiloxane comprises Telechelic SiH terminated polydimethylsiloxane with degree of polymerization=100.

20. The process of claim 1, where the terminal olefinic compound is present.
